(19) United States
(12) Patent Application Publication
(10) Pub. No.: US 2014/0204092 A1
(43) Pub. Date: Jul. 24, 2014

(54) CLASSIFICATION OF HIGH DIMENSIONAL DATA

(71) Applicant: THE REGENTS OF THE UNIVERSITY OF CALIFORNIA, (US)

(72) Inventors: Andrea Bertozzi, Santa Monica, CA (US); Arjuna Flenner, Claremont, CA (US)

(21) Appl. No.: 13/859,721

(22) Filed: Apr. 9, 2013

Related U.S. Application Data
(60) Provisional application No. 61/621,826, filed on Apr. 9, 2012.

(51) Int. Cl. G06T 11/20

(52) U.S. Cl. CPC G06T 11/206
USPC 345/440

(57) ABSTRACT

A method for classification of high dimensional data on graphs based on the Ginzburg-Landau functional. The method applies L² gradient flow minimization of the Ginzburg-Landau diffuse interface energy functional to the case of functions defined on graphs. The method performs binary segmentations in a semi-supervised learning (SSL) framework and multiclass tasks are solved by recursively applying a sequence of binary segmentations. Examples illustrate the versatility of the methods on a variety of datasets including congressional voting records, high dimensional test data, and machine learning in image processing.

### CROSS-REFERENCE TO RELATED APPLICATIONS

This application is a nonprovisional of U.S. provisional patent application Ser. No. 61/621,826 filed on Apr. 9, 2012, incorporated herein by reference in its entirety.

### STATEMENT REGARDING FEDERALLY SPONSORED RESEARCH OR DEVELOPMENT

This invention was made with Government support under grant numbers FA9550-10-1-0569, N00014-08-1-0363, N00014-10-1-0221 and N00014-12-AF-00002 awarded by the United States Navy, Office of Naval Research. The Government has certain rights in this invention.

### INCORPORATION-BY-REFERENCE OF MATERIAL SUBMITTED ON A COMPACT DISC

Not Applicable

### BACKGROUND OF THE INVENTION

1. Field of Invention

This invention pertains to the data processing and classification of high dimensional data on graphs and more particularly to a graph-based segmentation procedure that applies L² gradient flow minimization of the Ginzburg-Landau (GL) diffuse interface energy functional to the case of functions defined on graphs.

2. Background

Many practical applications of data classification and data mining can be resource intensive. For example, high dimensional data (i.e., data sets with hundreds or thousands of features) may contain large amounts of irrelevant and redundant information. In the case of machine learning, high dimensional data can degrade predictive accuracy, decrease learning performance and efficiency. Therefore, the selection of features and data labels and classifications can be an essential pre-processing step with machine learning and high dimensional data.

Similarly, segmentation of an image is a fundamental problem in computer vision and machine learning. Partitioning or segmenting an entire image into distinct recognizable regions is a central challenge in computer vision which has received increasing attention in recent years.

Most multi-class image segmentation methods are aimed at object recognition and attempt to classify all pixels in an image rather than attempting to recognize an object. This is usually accomplished by the segmentation method accounting for the local pixels or regions and then classifying contiguous regions or analogous regions.

Accordingly, there is a need for methods for classifying high dimensional data on graphs that are accurate and efficient. The present invention satisfies these needs as well as others and is generally an improvement over the art.

### SUMMARY OF THE INVENTION

The present invention generally provides methods for classification of high dimensional data that can be adapted to classifying data from different sources. The methods are a generalization of a graph-based segmentation procedure that applies L² gradient flow minimization of the Ginzburg-Landau (GL) diffuse interface energy functional to the case of functions defined on graphs.

Diffuse interface models in Euclidean space may be built around the Ginzburg-Landau functional:

$$GL ( u ) = \frac{ε}{2} \int {\vert ∇ u \vert}^{2} d x + \frac{1}{ε} \int W ( u ) d x ,$$

where W is a double well potential. For example

$$W ( u ) = \frac{1}{4} {( {u}^{2} - 1 )}^{2}$$

minimizers at plus and minus one. The operator ∇ denotes the spatial gradient operator and the first term in GL is ε/2 times the H¹ semi-norm of u. The small parameter ε represents a spatial scale, the diffuse interface scale. The model is called “diffuse interface” because there is a competition between the two terms in the energy functional. Upon minimization of this functional, the double well will force u to go to either one or negative one, however, the H¹ term forces u to have some smoothness, thereby removing sharp jumps between the two minima of W.

In a typical application, minimization of an energy functional is desired in the form:

E(u)=GL(u)+λF(u,u₀),

where F(u, u₀) is a fitting term to known data. In the case of denoising, F(u, u₀) is often just an L² fit, ∫u−u₀)². In the case of deblurring it is ∫(K*u−u₀)², or the L² of the blurred solution with the data. For inpainting we often have an L² fit to known data in the region where the data is known, i.e. ∫_{Ω}(u−u₀)².

One of the reasons to choose the GL functional instead of TV is that the minimization procedure for GL often involves the first variation of GL for which the highest order term, involving the Laplace operator, is linear. Thus if one has fast solvers for the Laplace operator or relatives of it, one can take advantage of this in designing convex splitting schemes. A particular class of fast solvers are ones in which the Laplacian can be transformed so that the operator diagonalizes.

In the graph-based examples, fast methods are used for directly diagonalizing the graph Laplacian, either through standard sparse linear algebra routines, or in the case of fully connected weighted graphs, Nyström extension methods. Convex splitting schemes are based on the idea that an energy functional can be written as the sum of convex and concave parts:

E(u)=Eᵥₑₓ(u)−E_{cave}(u),

where this decomposition is certainly not unique because we can add and subtract any convex function and not change E but certainly change the convex/concave splitting. The idea behind convex splitting for the gradient descent problem is to perform a time stepping scheme in which the convex part is done implicitly and the concave part explicitly. The challenge then lies in choosing the splitting so that the resulting scheme is stable and also computationally efficient to solve.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a flow diagram of semi-supervised classification learning on graphs according to one embodiment of the invention.

FIG. 2 is a flow diagram for convex splitting for the graph Laplacian according to one embodiment of the invention.

FIG. 3 is a flow diagram for a Nyström Extension for symmetric graph Laplacian according to one embodiment of the invention.

### DETAILED DESCRIPTION OF THE INVENTION

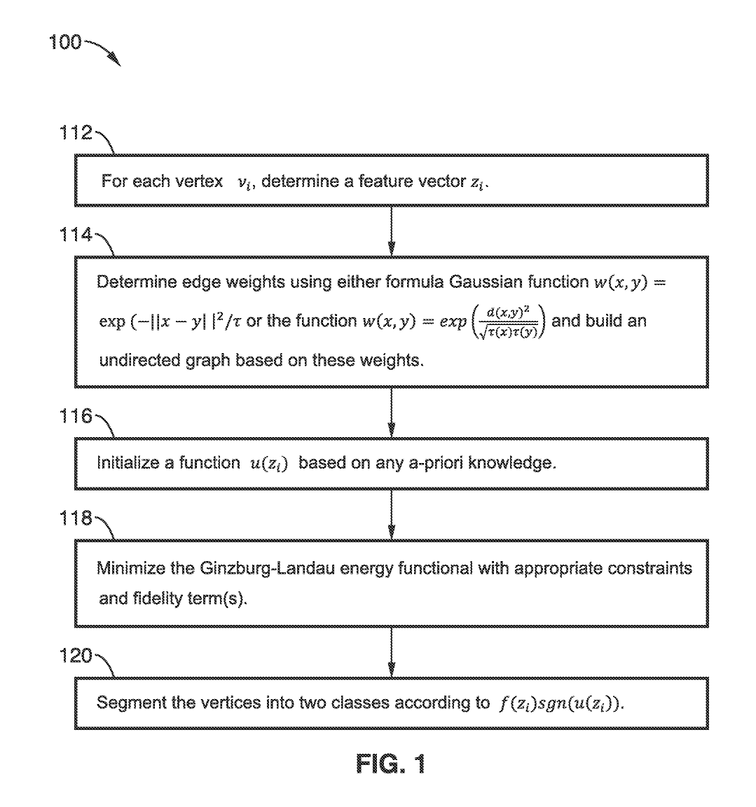

Referring more specifically to the drawings, for illustrative purposes several embodiments of the methods for the classification of high dimensional data on graphs of the present invention are depicted generally in FIG. 1 through FIG. 3. It will be appreciated that the methods may vary as to the specific steps and sequence without departing from the basic concepts as disclosed herein. The method steps are merely exemplary of the order that these steps may occur. The steps may occur in any order that is desired, such that it still performs the goals of the claimed invention.

By way of example, and not of limitation, FIG. 1 illustrates schematically a method 100 for classifying high dimensional data. Generally, the methods utilize a graph Laplacian incorporated into a Ginzburg-Landau type functional. The method shown in FIG. 1 has been adapted for semi-supervised or unsupervised classification learning on graphs.

At block 112, an initial set of features are determined given a set of vertices V={vₙ}n=1^{N}. Then a graph is built at block 114 based on edge weights or other weighted parameters. The function u(zᵢ) is initialized at block 116 based on any a priori knowledge. At block 118, the Ginzburg-Landau energy functional is minimized with appropriate constraints and fidelity term(s). The vertices are then segmented into two classes at block 120.

Referring again to block 112, for each vertex vᵢ, a feature vector zᵢ is determined. For example, in the case of an undirected graph G=(V, E) with vertex set V={vₙ}ₙ₌₁^{N} and an edge set E. A weighted undirected graph has an associated weight function w: V×V→R satisfying w(v,μ)=w(μ, v) and w(v,μ)=w≧0. The degree of a vertex vεV is defined as:

$$d ( υ ) = {\sum }_{μ ∈ V} d ( υ ) .$$

The degree matrix D can then be defined as the N×N diagonal matrix with diagonal elements d(v). The size of a subset A⊂V will be important for segmentation using graph theory, and there are two important size measurements. For A⊂V define:
   |A|:=the number of vertices in A,

$$vol ( A ) := {\sum }_{υ ∈ A} d ( υ ) .$$

The topology of the graph also plays a role. A subset A⊂V of a graph is connected if any two vertices in A can be joined by a path such that all the points also lie in A. A subset of A is called a connected component if it is connected and if A and Ā are not connected. The sets A₁, A₂, . . . , Aₖ form a partition of the graph if Aᵢ∩Aⱼ=ø and ∪ₖ Aₖ=V.

The graph Laplacian is the main tool for graph theory based segmentation. The graph Laplacian L(v,μ) is defined as:

$$L ( υ , μ ) = \{ \begin{matrix}d ( υ ) & if υ = μ \\ - w ( υ , μ ) & otherwise .\end{matrix}$$

The graph Laplacian can be written in matrix form as L=D−W where W is the matrix w(v,μ). The following definition and property of L are important:

1. (quadratic form) For every vector uεR^{N}

$${〈 u , Lu 〉 = \frac{1}{2} {\sum }_{μ , υ ∈ V} w ( υ , μ ) u ( υ ) - u ( μ ) )}^{2} .$$

2. (eigenvalue) L has N non-negative, real valued eigenvalues with 0=\tilde{λ}₁≦λ₂≦ . . . ≦\tilde{λ}_{N}, and the eigenvector of \tilde{λ}₁ is the constant N dimensional one vector 1_{N}.}

The Quadratic form is exploited to define a minimization procedure as in the Allen-Chan equation above. The Eigenvalue condition gives limitations on the spectral decomposition of the matrix L. These spectral properties are essential for spectral clustering algorithms discussed below.

There are two preferred normalization procedures for the graph Laplacian, and the normalization has segmentation consequences. One particularly preferred normalization procedure is the symmetric Laplacian Lₛ defined as:

$${L}_{8} = {D}^{- 1 / 2} {LD}^{- 1 / 2} = I - {D}^{- \frac{1}{2}} {WD}^{- \frac{1}{2}} .$$

The symmetric Laplacian is named as such since it is a symmetric matrix.

The random walk Laplacian is another important normalization given by:

L_{w}=D⁻¹L=I−D⁻¹W.

The random walk Laplacian is closely related to discrete Markov processes may also be used.

The spectrum of the graph Laplacian is used for graph segmentation. The spectrum of Lₛ and L_{w} are the same, but the eigenvectors are different. The easily verifiable spectral relationships between L_{w} and Lₛ are listed below.

1. \tilde{λ} is an eigenvalue of L_{w} if and only if \tilde{λ} is an eigenvalue of Lₛ.

2. ψ is an eigenvector of L_{w} if and only if D^{1/2}ψ is an eigenvector of L.

3. \tilde{λ} is an eigenvalue of L_{w} with eigenvector ψ if and only if Lψ=\tilde{λ}Dψ.

At block 114, a graph Laplacian using weight functions is used. The weight functions w(x,y), sometimes referred to as similarity functions, are constructed for specific applications involving high dimensional data. There are two factors to consider when choosing w(x,y). First, the choice of weight function must reflect the desired outcome. For segmentation, this typically involves choosing an appropriate metric on a vector space. In the examples below, the standard Euclidean norm was used. However, it will be understood that other norms may be more appropriate. For example, the angle norm may work better for the segmentation of hyperspectral images.

A second consideration in the selection of similarity or weight function is overall algorithm speed. The segmentation algorithms below requires the diagonalization of w(x,y), and this step is often the rate limiting step of the procedure. There are two main methods to obtain speed in the diagonalization.

The first method is to use the Nyström extension described below. This method does not require a modification of w(x,y), and calculations on large graphs with connections between every vertex are possible.

The second method is to create a sparse graph. A sparse graph can be created by only keeping the N largest values of w(x,y) for each fixed x. Note that such a graph is not symmetric, but it can easily be made symmetric to aid in computation.

The two preferred techniques to create the similarity function, w(x,y), are as follows:
1. The Gaussian function w(x, y)=exp (−∥x−y∥²/τ is one preferred similarity function. Depending on the choice of metric, this similarity function may include the Yaroslaysky filter and/or the non-local means filter.
2. Zelnik-Manor and Perona introduced local scaling weights for sparse matrix computations that starts with a metric d(xᵢ, xⱼ) between each sample point. The idea is to define a local parameter \sqrt{τ(xᵢ)} for each xᵢ. In one embodiment, the selected parameter is \sqrt{τ(xᵢ)}=d(xᵢ, x_{M}) where x_{M} is the M^{th} closest vector to xᵢ. In another embodiment, the parameter is M=7 or M=10. The similarity matrix is then defined as:

$$w ( x , y ) = exp ( \frac{{d ( x , y )}^{2}}{\sqrt{τ ( x ) τ ( y )}} ) .$$

This similarity matrix is better at segmentation when there are multiple scales that need to be segmented simultaneously.

The goal of graph clustering is to partition the vertices into groups according to their similarities. Consider the weight function as a measure of the similarities, then the graph problem is equivalent to finding a partition of the vertices such that the sum of the edge weights between the groups are small compared with the sum of the edges within the groups. The weighted graph minimization algorithms in their original form are NP complete problems; therefore a relaxed problem can be formulated where the minimization function is allowed to be real valued, and such minimization problems are equivalent to the spectral clustering methods.

Segmentation problems naturally generate a graph structure from a set of vertices vᵢ each of which is assigned a vector zᵢε [symbol] ^{K}. For example, when considering voting records of the US House of Representatives in Example 1, each representative defines a vertex and their voting record defines a vector. A different example arises when considering similarity between regions in image data. Each pixel defines a vertex and one can assign a high dimensional vector to that pixel by comparing similarities between the neighborhood around that pixel and that of any other pixel. Given such an association, a symmetric weight matrix can be created using a symmetric function: ŵ(x, y): [symbol] ^{K}× [symbol] ^{K}→ [symbol] ₊. In particular, if vᵢ(y)=zᵢ represents the vector associated with the vertex vᵢ, then the weight matrix is a positive symmetric function. Ignoring the differences between these two functions the following equation is obtained: w(vᵢ,μⱼ)=ŵ(zᵢ,zⱼ)=w(zᵢ,zⱼ). Similar statements are true for any function u: V→ [symbol] .

Spectral clustering algorithms for binary segmentation consist of the following steps:

Input:

A set of vertices V with the associated set of vectors Z⊂R^{K}, a similarity measure w(x,y): R^{K}×R^{K}→R₊, and the integer k of clusters to construct.
1. Calculate the weight function w(x,) for all x,yεZ.
2. Compute the graph Laplacian L.
3. Compute the second eigenvector ψ₂ of L or the second eigenvector ψ₂ of the generalized eigenvalue problem Lψ=λDψ.
4. Segment ψ₂ into two clusters using k-means (with k=2).

Output:

A partition of V (or equivalently Z) into two clusters A and A.

Two characteristics of the spectral clustering algorithms are significant. First, the algorithm determines clusters using a k-means algorithm. It should be noted that the k-means algorithm is used to construct a partition of the real valued output, and any algorithm that performs this goal can be substituted for the k-means algorithm. A partitioning algorithm is preferably used since the relaxed problem does not force the final output function f to be binary valued. This is addressed by using the Ginzburg-Landau potential.

The second characteristic is that spectral clustering finds natural clusters through a constrained minimization problem. The constrained minimization problem exploits a finite number of eigenfunctions depending on the a-priori chosen number of clusters. A significant difference in the method of the invention is that it utilizes all of the eigenfunctions in the variational problem. One can interpret this as an issue of the number of scales that need to be resolved to perform the desired classification. For spectral clustering to work, the eigenfunctions used must capture all the relevant scales in the problem. By using all the eigenfunctions we resolve essentially all the scales in the problem, modulo the choice of ε. In the classical differential equation problem E selects a smallest length scale to be resolved for the interfacial problem. An analogous role could occur in the graph problem and thus it would make sense to use this method on large dataset problems rather than relatively small problems, for which other methods might be simpler.

Another important issue is the proper normalization of the graph Laplacian with scale. One issue with non-local operators is the behavior of the operators with increased sample size. Increasing sample size for the discrete Laplace operator corresponds to decreasing the grid size, and this operator must be correctly normalized in order to guarantee convergence to the differential Laplacian. It should be noted that in the case of the classical finite difference problem for PDEs the entire matrix is multiplied by N² where N is the number of vertices in one of the dimensions, this is essentially 1/dx, the spatial grid size. Recall that the largest eigenvalue of the operator scales like N² or 1/dx², which gives a stiffness constraint for forward time stepping of the heat equation, as a function of grid size. Moreover, with this scaling, the graph Laplacian converges to the continuum differential operator in the limit of large sample size, i.e. as N→∞ where N is the grid resolution along one of the coordinate axes.

Proper normalization conditions for convergence also exist for the graph Laplacian. The issue of sample size also comes into play but rather than convergence to a differential operator, we consider the density of vertices, in the case of spatial embeddings, which can be measured by the degree of each vertex. The normalized Laplace operator is known to have the correct scaling for spectral convergence of the operator in the limit of large sample size.

Therefore, the following assumptions are made:
1. The set of k vectors Z={zᵢ}ᵢ₌₁^{N} are sampled from a manifold in R^{K},
2. Each sample is drawn from an unknown distribution μ(z),
3. The graph Laplacian is a graph representation of the integrating kernel w(x,y) with vertex set V, and
4. Each vector in Z is assigned a vertex and weighted edges w(x,y) between every x,yεZ.

Consistency and practicality of the method requires similar and useful solutions as the number of samples increases. Furthermore, the computational methods are preferably stable. It should be noted that the eigenvectors of the discrete Laplacian converge to the eigenvectors of the Laplacian, i.e. the discrete Fourier modes converge to the continuous Fourier modes. Similarly, it has been shown that the spectrum of the graph Laplacian converges (compactly) to the corresponding integral operator. In addition, there is a dilemma with the convergence for clustering applications. In summary, the unnormalized Laplacian converges to the operator L defined by (Lu)(x)=d(x)u(x)−∫_{Ω}w(x,y)u(y)dy while the normalized Laplacian converges to Lₛ defined by (Lₛu)(x)=u(x)−∫_{Ω}(w(x,y)/{square root over (d(x) d(y)))}u(y)dy. Both operators are a sum of two operators, a multiplication operator and the operator w(x,y) or w(x,y)/\sqrt{d(x)d(y)}. The operators with kernels w(x,y) and w(x,y)/\sqrt{d(x)d(y)} are compact and thus have a countable spectrum. The operators d(x) and the identity operator 1 are multiplication operators, but the operator d(x) has an a-priori unknown value while the identity operator has an isolated eigenvalue. Note that the spectrum of a multiplication is the essential range of the operator d(x); therefore, by perturbation theory results, the essential spectrum of L is the essential spectrum of d(x).

Perturbation theory does not imply anything about the convergence of the eigenvalues inside the essential spectrum of the operator L. Therefore, it is not known if the function L is consistent with the increase in the number of samples. This problem is avoided if the normalized Laplacian is used instead.

There are numerous approaches to Semi-Supervised Learning (SSL) on graphs using graph theory. In contrast to current methods, the invention is based on an extension of a nonlinear geometric segmentation method that is applied to general graphs rather than lattices embedded in Euclidean space.

To illustrate the Ginzburg-Landau energy on graphs in a semi-supervised learning application, it is assumed that the acquired data is organized in a graphical structure in which each graph node zᵢεZ corresponds to a data vector xᵢ and the weights between the nodes are constructed as in block 114. The goal is to perform a binary segmention of the data on the graph based on a known subset of nodes (possibly very small) which is denoted by Z_{data}. We denote by λ the characteristic function of Z_{data}:

$$λ ( z ) = \{ \begin{matrix}1 & if z ∈ {Z}_{data} \\ 0 & otherwise ,\end{matrix}$$

The graph segmentation problem automatically finds a decomposition of the vertices Z into disjoint sets Zᵢₙ∪Zₒᵤₜ. These will be computed by assigning ±1 to each of the nodes using a variational procedure of minimizing a Ginzburg-Landau functional. The known data involves a subset of nodes for which +1 or −1 is already assigned, and denoted by u₀ in the variational method.

The Ginzburg-Landau functional for SSL is therefore:

$$E ( u ) = \frac{ε}{2} 〈 u , {L}_{s} u 〉 + \frac{1}{4 ε} {\sum }_{z ∈ Z} {( {u}^{2} ( z ) - 1 )}^{2} + {\sum }_{z ∈ Z} \frac{λ ( z )}{2} {( u ( z ) - {u}_{0} ( z ) )}^{2} .$$

The fidelity term uses a least-squares fit, allowing for a small amount of misclassification (i.e. noisy data) in the information supplied.

There are two main components to the algorithm: the choice of splitting schemes and the computation of the basis functions as eigenfunctions of the graph Laplacian. An efficient convex splitting scheme can be derived by writing the Ginzburg-Landau energy with fidelity as:

$$E ( u ) - {E}_{1} ( u ) - {E}_{2} ( u )$$

$$with$$

$${E}_{1} ( u ) = \frac{ε}{2} \int {\vert ∇ u ( x ) \vert}^{2} d x + \frac{c}{2} \int {\vert u ( x ) \vert}^{2} d x , \\ {E}_{2} ( u ) = - \frac{1}{4 ε} \int {( {u ( x )}^{2} - 1 )}^{2} d x + \frac{c}{2} \int {\vert u ( x ) \vert}^{2} d x - \int \frac{λ ( x )}{2} {( u ( x ) - {u}_{0} ( x ) )}^{2} d x .$$

It is noted that the energy E₂ is not strictly concave, but it is possible to choose the constant c such that it is concave for u near and inbetween the potential wells of (u²−1)². This scheme is preferably chosen so the nonlinear term is in the explicit part of the splitting. Given the above splitting and since the Fourier transform diagonalizes the Laplace operator, the following numerical scheme solves the Euler-Lagrange equations:

$${a}_{k}^{( n )} = \int {e}^{ikx} {u}^{( n )} ( x ) d x , \\ {b}_{k}^{( n )} = \int {{e}^{ikx} ( {u}^{( n )} )}^{3} ( x ) d x , \\ {d}_{k}^{( n )} \int {e}^{ikx} λ ( x ) ( {u}^{( n )} ( x ) - {u}_{0} ( x ) ) d x , \\ {𝒟}_{k} = 1 + dt ( ε {k}^{2} + c ) , \\ {a}_{k}^{( n + 1 )} = {𝒟}_{k}^{- 1} [ ( 1 + \frac{dt}{ε} + cdt ) {a}_{k}^{( n )} - \frac{dt}{ε} {b}_{k}^{( n )} - dt ( {d}_{k}^{( n )} ) ] .$$

Note that the H¹ semi norm is convex and thus appeared in the convex part of the energy splitting. The first variation of that yields the Laplace operator which is a stiff operator to have in an evolution equation. The stiffness results because the eigenvalues of the Laplace operator range from order one negative values to minus infinity. Or in the case of a discrete approximation of the Laplace operator, the eigenvalues range from order one to minus one divided by the square of the smallest length scale of resolution (e.g. the spatial grid size in a finite element or finite difference approximation). By projecting onto the eigenfunctions of the Laplacian, we see that there are many different timescales of decay in the spatial operator and all must be resolved numerically in the case of a forward time stepping scheme. However when the Laplace operator is evaluated implicitly, at the new time level, one need not resolve the fastest timescales in the time-stepping scheme.

The same time-stepping scheme can be used if the spectral decomposition of the graph Laplacian is used instead of the Laplacian, and we can use the spectral decomposition for any of the graph Laplacians L, L_{w} or Lₛ. We used the spectrum of Lₛ due to the convergence and scaling issues discussed above. Here is a summary of the method as used in this paper:

Decompose the solution u⁽ⁿ⁾ at each time step according to the known eigenvectors {φₖ(x)} of Lₛ:

$${u}^{( n )} ( x ) = {\sum }_{k} {a}_{k}^{( n )} {φ}_{k} ( x ) .$$

Likewise we need to decompose the pointwise cube of u and the fidelity term,

$${[ {u}^{( n )} ( x ) ]}^{3} = {\sum }_{k} {b}_{k}^{( n )} {φ}_{k} ( x ) , \\ λ ( x ) ( {u}^{( n )} ( x ) - {u}_{0} ( x ) ) = {\sum }_{k} {d}_{k}^{( n )} {φ}_{k} ( x ) .$$

Then the algorithm for the next iteration is given in terms of the coefficients for:

$${u}^{( n + 1 )} ( x ) = {\sum }_{k} {a}_{k}^{( n + 1 )} {φ}_{k} ( x )$$

in terms of its decomposition using the eigenfunctions of Lₛ again as a basis for the solution. Define \tilde{λ}ₖ to be the eigenvalue associated with the eigenfunction φₖ(x), i.e. Lₛφₖ=\tilde{λ}ₖφₖ; then the update equation for aₖ⁽ⁿ⁾ is:

$${𝒟}_{k} = 1 + dt ( {\tilde{λ}}_{k} + c ) , \\ {a}_{k}^{( n + 1 )} = {𝒟}_{k}^{- 1} [ ( 1 + \frac{dt}{ε} + cdt ) {a}_{k}^{( n )} - \frac{dt}{ε} {b}_{k}^{( n )} - dt ( {d}_{k}^{( n )} ) ] .$$

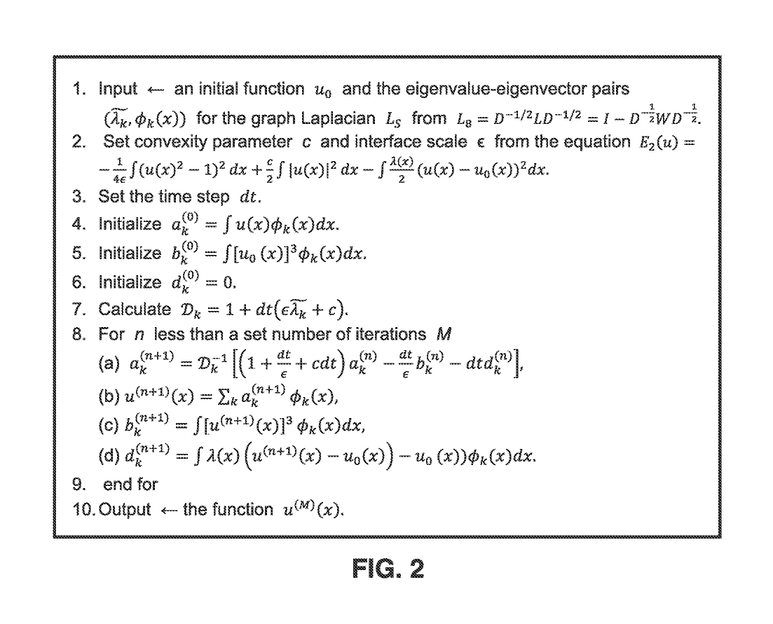

Referring also to FIG. 2, the preferred scheme for convex splitting for the graph Laplacian is set forth. This scheme is a generalization of a classical “psuedospectral” scheme for PDEs in which one goes back and forth between the spectral domain (the coefficients aᵢ⁽ⁿ⁾) and the graph domain in which the u is evaluated directly at every vertex on the graph. The latter must be done in order to compute the cube [u⁽ⁿ⁾(x)]³ and the fidelity term λ(x)(u⁽ⁿ⁾(x)−u₀(x)) which can then be projected back to the spectral domain. Here the convex temporal splitting is important because it effectively removes the stiffness inherent in the diverse time scales that arise from the range of eigenvalues of the graph Laplacian.

The method is particularly useful in combination with a fast method for determining the eigenfunctions φₖ(x) and their corresponding eigenvalues. For the case of fully connected graphs the Nyström extension is used.

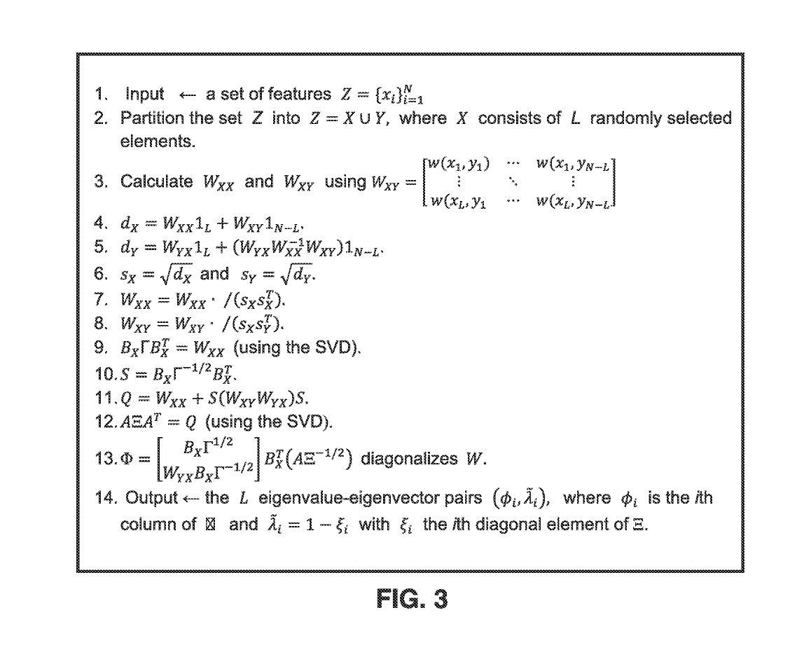

FIG. 3 summarizes the Nyström extension steps for symmetric graph Laplacian. With the Nyström extension for fully connected graphs, the spectral decomposition of the matrix Lₛ is related to the spectral decomposition:

D^{-1/2}WD^{-1/2}φ=ξφ

through the relationship:

$$\begin{matrix}{L}_{S} φ = ( 1 - {D}^{- 1 / 2} {WD}^{- 1 / 2} ) φ \\ = ( 1 - ξ ) φ \\ = \tilde{λ} φ .\end{matrix}$$

Therefore, the convex splitting scheme is efficient if the spectral decomposition of the matrix D^{-1/2}WD^{-1/2} can be quickly found. The matrix W, however, is a large matrix and it cannot be assumed that the matrix will be sparse. The Nyström method is a technique to perform matrix completion that has been used in a variety of image processing applications including spectral clustering, kernel principle component analysis, and fast Gaussian process calculations.

The Nyström method approximates the eigenvalue equation:

∫_{Ω}w(y,x)φ(x)dx=γφ(y)

using a quadrature rule. Recall that a quadrature rule is a technique to find L interpolation weights aⱼ(y) and a set of L interpolation points X={xⱼ} such that:

$${\sum }_{j = 1}^{L} {a}_{j} ( y ) φ ( {x}_{j} ) = {\int }_{Ω} w ( y , x ) φ ( x ) d x + E ( y ) ,$$

where E(x) is the error in the approximation. The model, however, does not allow us to choose the interpolation points, but rather the interpolation points are randomly samples from some sample space.

Recall that Z={zᵢ}ᵢ₌₁^{N} is the set of nodes on the graph. However it also defines an N-dimensional vector space with W as a linear operator on that space. The Nyström method is used to approximate the eigenvalues of the matrix W with components w(zᵢ,zⱼ). A key idea used to produce a fast algorithm is to choose a randomly sampled subset X={xᵢ}ᵢ₌₁^{L} of the entire graph Z to use as interpolation points, and the interpolation weights are the values of the weight function aⱼ(y)=w(y,xⱼ).

Partition Z into two sets X and Y with Z=X∪Y and X∩Y= [symbol] . Furthermore, create the set X by randomly sampling L points from Z. Let φₖ(x) be the k^{th} eigenvector for W. The Nyström extension approximates the value of φₖ(yᵢ), up to a scaling factor, using the system of equation:

$${\sum }_{{x}_{j} ∈ X} w ( {y}_{i} , {x}_{j} ) {φ}_{k} ( {x}_{j} ) = {λφ}_{k} ( {y}_{i} ) .$$

This equation cannot be calculated directly since the eigenvectors φₖ(x) are not initially known. This problem is overcome by first approximating the eigenvectors of W with the eigenvectors of a sub-matrix of W. These approximate eigenvalues, however, may not be orthogonal. The approximate eigenvectors will then be orthogonalized, and this final set of eigenvectors will serve as an approximation to the eigenvectors of the complete matrix W. Note that since only a subset of the matrix W is initially used, only a subset of the eigenvectors can be approximated using this method.

$${W}_{XY} = [ \begin{matrix}w ( {x}_{1} , {y}_{1} ) & … & w ( {x}_{1} , {y}_{N - L} \\ ⋮ & ⋱ & ⋮ \\ w ( {x}_{L} , {y}_{1} & … & w ( {x}_{L} , {y}_{N - L}\end{matrix} ]$$

Similarly, define the matrices W_{XX} and W_{YY} and the vectors φ_{X} and φ_{Y}. The matrix Wε [symbol] ^{K}× [symbol] ^{K} and vectors φε [symbol] ^{K} can be written as

$$W = [ \begin{matrix}{W}_{XX} & {W}_{XY} \\ {W}_{YX} & {W}_{YY}\end{matrix} ]$$

and φ=[φ_{X}^{T}φ_{Y}^{T}]^{T} with φ^{T} denoting the transpose operation.

The spectral decomposition of W_{XX} is W_{XX}=B_{X}ΓB_{X}^{T} where B_{X} is the eigenvector matrix of W_{XX} with each column an eigenvector and Γ=diag(γ₁, γ₂, . . . , γ_{L}) are the corresponding eigenvalues. The Nyström extension of equation:

$${\sum }_{{x}_{j} ∈ X} w ( {y}_{i} , {x}_{j} ) {φ}_{k} ( {x}_{j} ) = {λφ}_{k} ( {y}_{i} ) .$$

in matrix form using the interpolation points X is

B_{Y}=W_{YX}B_{X}Γ⁻¹.

In short, the n eigenvectors of W are approximated by B=[B_{X}^{T}(W_{YX}B_{X}Γ⁻¹)^{T}]^{T}. The associated approximation of W=BΓB^{T} is:

$$W = \begin{matrix}{W}_{XX} \\ {W}_{YX}\end{matrix} \begin{matrix}{W}_{XY} \\ {W}_{YX} {W}_{XX}^{- 1} {W}_{XY}\end{matrix}$$

From this equation, it can be shown that the large matrix W_{YY} is approximated by:

W_{YY}≈W_{YX}W_{XX}⁻¹W_{XY}.

In addition, the quality of the approximation to W_{yy} is given by the norm ∥W_{YY}−W_{YX}W_{XX}⁻¹W_{XY}∥, and this is determined by how well W_{YY} is spanned by the columns of W_{XY}.

This decomposition is unsatisfactory since the approximate eigenvectors φᵢ(x) defined above are not orthogonal. This deficiency can be fixed using the following trick. For arbitrary unitary A and diagonal matrix Ξ then if:

$$Φ = [ \begin{matrix}{W}_{XX} \\ {W}_{YX}\end{matrix} ] ( {B}_{X} {Γ}^{- 1 / 2} {B}_{X}^{T} ) ( A {Ξ}^{- 1 / 2} ) ,$$

the matrix W can be written as W=ΦΞΦ^{T}. We are therefore free to choose A unitary such that Φ^{T}Φ=1.

If such a matrix A can be found, then the matrix W will be diagonalized using the unitary matrix Φ. Define the operator Y=AΞ^{-1/2}, then the proper choice of A is given through the relationship:

$${Φ}^{T} Φ = {( {Y}^{T} )}^{- 1} {W}_{XX} {Y}^{- 1} + {( {Y}^{T} )}^{- 1} {W}_{XX}^{- \frac{1}{2}} {W}_{XY} {W}_{YX} {W}_{XX}^{- \frac{1}{2}} {Y}^{- 1} .$$

If Φ^{T}Φ1 then after multiplying the last equation on the right by Ξ^{1/2}A and on the left by the transpose we have:

A^{T}ΞA=W_{XX}+W_{XX}^{-1/2}W_{XY}W_{YX}W_{XX}^{-1/2}.

Therefore, if the matrix W_{XX}+W_{XX}^{-1/2}W_{XY}W_{YX}W_{XX}^{-1/2} is diagonalized, then its spectral decomposition can be used to find an approximate orthogonal decomposition of W with eiqenvectors Φ given by the equation:

$$Φ = [ \begin{matrix}{W}_{XX} \\ {W}_{YX}\end{matrix} ] ( {B}_{X} {Γ}^{- 1 / 2} {B}_{X}^{T} ) ( A {Ξ}^{- 1 / 2} ) .$$

The matrix W must also be normalized in order to use Lₛ for segmentation. Normalization of the matrix is a straightforward application. In particular, let 1_{K} be the K dimensional unit vector, then define [d_{X}^{T}d_{Y}^{T}]^{T} as:

$$\begin{matrix}[ \begin{matrix}{d}_{X} \\ {d}_{T}\end{matrix} ] = [ \begin{matrix}{W}_{XX} & {W}_{XY} \\ {W}_{YX} & {W}_{YX} {W}_{XX}^{- 1} {W}_{XY}\end{matrix} ] [ \begin{matrix}{1}_{K} \\ {1}_{N - L}\end{matrix} ] \\ = [ \begin{matrix}{W}_{XX} {1}_{K} + {W}_{XY} {1}_{N - L} \\ {W}_{YX} {1}_{K} + ( {W}_{YX} {W}_{X}^{- 1} {W}_{XY} ) {1}_{N - L}\end{matrix} ] .\end{matrix}$$

Where A ./ B denotes component-wise division between two matrices A and B and xy^{T} the outer product of two vectors, then the matrices W_{XX} and W_{XY} can be normalized by:

W̅_{XX}=W_{XX}·/(S_{X}S_{X}^{T}),

W̅_{XY}=W_{XY}·/(S_{X}S_{Y}^{T}),

where Sₓ=√d_{X} and s_{Y}=√d_{Y}.

Accordingly, the Ginzburg-Landau energy functional can be used for unsupervised and semi-supervised classification learning on graphs.

The invention may be better understood with reference to the accompanying examples, which are intended for purposes of illustration only and should not be construed as in any sense limiting the scope of the present invention as defined in the claims appended hereto.

### Example 1

In order to demonstrate the methods, several different data sets were obtained and classified using a semi-supervised learning (SSL) adaptation. Given a set of vertices V={vᵢ}^{l}ᵢ^{v}_{—1}, the general procedure consists of the following SSL steps:

1. Determine Features: For each vertex vᵢ, determine a feature vector zᵢ.

2. Build Graph: Determine edge weights using either formula Gaussian function w(x, y)=exp (−∥x−y∥²/τ or the function

$$w ( x , y ) = exp ( \frac{{d ( x , y )}^{2}}{\sqrt{τ ( x ) τ ( y )}} )$$

and build an undirected graph based on these weights.

3. Initialization: Initialize a function u(zᵢ) based on any a-priori knowledge.

4. Minimization: Minimize the Ginzburg-Landau energy functional with appropriate constraints and fidelity term(s). Note that for all experiments we use the normalized Laplacian Lₛ.

5. Segmentation: Segment the vertices into two classes according to f(zᵢ)sgn(u(zᵢ)). Each of the vertices represents the objects that are to be segmented, and the feature vectors provide distinguishing characteristics between the objects.

The first data set that was evaluated using the voting records from 1984 from the House of Representatives. The US House or Representatives voting records data set consists of 435 individuals where each individual represents a vertex of the graph. The goal is to use SSL to segment the data into the two party affiliation of either Democrat or Republican. The SSL algorithm was performed by assuming a party affiliation of five individuals, two Democrats and Three Republicans, and segmenting the rest. The votes were taken in 1984 from the 98th United States Congress, 2nd session.

A 16 dimensional feature vector was created using 16 votes recorded for each individual in the following manner. A yes vote was set to one, while a no vote was set to negative one. The voting records had a third category called the “did not vote” category. Each did not vote recording was represented by a zero in the feature vector. A fully weighted graph was then created using Gaussian similarity function that was described previously using T=0.3. The function, u(z) was initialized to one for the two Democrats, negative one for the three Republicans, and zero for the rest of the classes. The Ginzburg-Landau function with fidelity, equation:

$$E ( u ) = \frac{ε}{2} 〈 u , {L}_{s} u 〉 + \frac{1}{4 ɛ} {\sum }_{z ∈ Z}^{ } {( {u}^{2} ( z ) - 1 )}^{2} + {\sum }_{z ∈ Z}^{ } \frac{λ ( z )}{2} {( u ( z ) - {u}_{0} ( z ) )}^{2} ,$$

was then minimized using the convex splitting algorithm with parameters c=1, dt=0.1, ε=2, and 500 iterations. In the fidelity terms, we chose λ=1 for each of the five known individuals and λ=0 for the rest. This segmentation yielded 95.13% correct results. Note that due to the small size of this graph, we did not use the Nyström extension to compute the spectrum.

The probability of the party affiliation, given the vote, was above 90% for some of the votes. We investigated the accuracy of the segmentation when these votes were removed. The accuracy of the method, when the 14, 12, 10, and 8 least predictive votes were used for the analysis, was shown to be 91.42%, 90.95%, 85.92%, and 77.49% respectively.

Conventional approaches of this dataset using a naive Bayesian decision tree method produce a 96.6% classification accuracy using 80% of the data for training and 20% for classification. In contrast, the present methods used only 1.15% of the data (5 samples out of 435) to obtain a classification accuracy of 95.13%. Other approaches use clustering aggregation to automatically determine the number of classes and class membership. These methods normally obtain an 89% correct classification in contrast to the 95.13% in the present case where only two clusters were specified.

### Example 2

A second illustration of the methods is presented using the same general procedure as shown in Example 1 as applied to the “Two Moon” dataset used in connection with spectral clustering using the p-Laplacian. This data set is constructed using two half circles in R² with radius one. The first half circle is contained in the upper half plane with a center at the origin, while the second half circle is created by taking the half circle in the lower half plane and shifting it to (1, 0.5). The two half circles are then embedded in R¹⁰⁰. Two thousand data points are sampled from the circles and independent and identically distributed Gaussian noise with standard deviation of 0.02 is added to each of the 100 dimensions. The goal was to segment the two half circles using unsupervised segmentation. The unsupervised segmentation was accomplished by adding a mean zero constraint to the variational problem.

In order to make quantitative comparisons, a graph was constructed using a 10 nearest neighbor weighted graph from the data using the self-tuning weights of Zelnik-Manor and Perona discussed in above where M was set to 10. This produced a difficult segmentation problem since the embedding and noise created a complex graphical structure.

The function u(z) was initialized using the second eigenfunction of the Laplacian. More specifically, the equation u(z)=sgn(φ₂(z)−φ₂) was set, where φ₂(z) is the second eigenfunction and φ̅₂̅ is the mean of the second eigenfunction. This initialization was used since the second eigenfunction approximates the relaxed graph cut solution. The Ginzburg-Landau energy was minimized with the mean constraint, ∫u(x)dx=0, but without any fidelity terms. The Nyström extension is ineffective for sparse graphs. Instead, we used the first 20 eigenvectors using Matlab's sparse matrix algorithms.

The results were compared with the results of the classical spectral clustering method. It was clear that spectral clustering using the second eigenvector of the Laplacian does not segment the two half moons accurately. However, the method accurately segmented this data set with an error rate of 2.1%.

Reducing the Ginzburg-Landau energy parameter E raises the potential barrier between the two states in the Ginzburg-Landau potential function and reduces the effect of the graph weights. Reducing E corresponds to reducing the scale of the graph and allows for a sharper transition between the two states.

The change in scale was shown to achieve better segmentation with reduced ε. The ε=10 case is essentially the spectral clustering solution, while the ε=2 case closely resembles the typical 1-Laplacian solution. A high quality segmentation in which 94.55% of the samples were classified correct occurs when the parameter ε was set to two. This is contrasted with the second eigenvector spectral clustering technique that obtained 82.85% correct classification, essentially equivalent to the large ε=10 case.

Better segmentation can be achieved if the algorithm is repeated while reducing E using the last segmentation as the initialization. The method of successive reductions in E was also used for image inpainting via the Cahn-Hilliard equation.

The final segmentation produced a 97.7% accuracy. This segmentation was compared to the 1-Laplacian Inverse Power Method (IPM) and the Normalized 1-Laplacian algorithm of Buhler and Hein with 10 initializations and 5 inner loops was used to obtain 97.3% accuracy for this data set. The computational time and accuracy of the 1-Laplacian method and the Ginzburg-Landau technique of the method were compared and the present method was able to obtain more accurate results in substantially less computational time than conventional methods.

### Example 3

A third illustration of the methods using the same general procedure as shown in Example 1 was applied to a digital image labeling dataset. The objective of image segmentation is to partition an image into multiple components where each component is a set of pixels. Furthermore, each component represents a certain object or class of objects. We are interested in the binary segmentation problem where each pixel can belong to one of two classes.

Most image segmentation algorithms in the art assume that a segmented region is connected in the image. Rather than make this assumption, a graph was built based on feature vectors derived from a neighborhood of each pixel, and the image was segmented based on a partition of the graph. The graph based segmentation allows the labeling of the unknown content of one image based on the known content of another image. Two images where one of the images has been hand segmented into two classes were used as input to the segmentation algorithm. The goal was to automatically segment the second image based on the segmentation of the first image.

Each pixel y represented a vertex of the graph. The features vectors that were associated to each vertex y were defined using a pixel neighborhood N(y) around y. For example, a typical choice for a pixel neighborhood on a Cartesian grid Ω=Z² is the set:

N(y)={zεΩ: |z₁−y₁|+|z₂−y₂|≦M}

for some integer M. A feature vector derived from a finite sized neighborhood of a pixel is called a pixel neighborhood feature.

An example of a pixel neighborhood feature in an image “I” is the set of image pixel values z(y)=I(N(y)) chosen in a consistent order. Another example is to calculate a collection of filter responses for each pixel, i.e. z(x)=((g₁*I)(x), (g₂*I)(x), . . . , (gⱼ*I)(x)), where gᵢ represents a filter for each “I”, and the “*” is the convolution operator. The proper choice of neighborhood and features are application dependent.

A fully connected graph is generated using the pixels from two images as vertices and the weight matrix w(x,y) for edge weights. This graph construction was very general and can be used to segment many different types of objects based on their determining features. For example, color and texture features are appropriate for segmenting trees and grass from other objects. It was also noted that the metric used in the weight matrix can be modified depending on the data set. For example, the spectral angle may be more appropriate for segmentation of hyperspectral images.

To illustrate the image labeling technique, a digital image was selected from an image database.

On each image, the function u(z) was initialized to one for one of the classes and negative one for the other class. The function u(z) was initialized to zero on the unlabeled image. The graph Laplacian was then constructed using the Gaussian function: w(x,y,)=exp(−∥x−y∥2/τ. The Ginzburg-Landau energy with fidelity was then minimized. The parameter values were as follows: τ=0.1, dt=0.01, ε=0.1, c=21 and 500 iterations. The fidelity term A was set to one on the initial image and to zero on the unknown image. The Nyström extension was used to determine the spectral decomposition of the weight matrix. The labels of the second image was then determined by the sign of u(z) on the second image.

In all examples, the predominant features were identified, and some of the pixels with few representative features were removed. No post-processing filters were needed.

From the discussion above it will be appreciated that the invention can be embodied in various ways, including the following:

1. A method for classifying high dimensional data comprising: (a) specifying an initial set of features within a data set of high dimensional data; (b) determining edge weights with a similarity function w(x,y); (c) building a graph based on the determined edge weights; (d) minimizing a Ginzburg-Landau energy functional with one or more constraints or fidelity terms; and (e) segmenting data into two classes.

2. The method as recited in embodiment 1, wherein the similarity function comprises a Gaussian function w(x, y)=exp(−∥x−y∥²/τ.

3. The method as recited in any previous embodiment, wherein the similarity function comprises:

$$w ( x , y ) = exp ( \frac{{d ( x , y )}^{2}}{\sqrt{τ ( x ) τ ( y )}} ) .$$

4. The method as recited in any previous embodiment, wherein the Ginzburg-Landau energy functional constraint comprises a double well potential.

5. The method as recited in any previous embodiment, wherein the Ginzburg-Landau energy functional constraint comprises an H⁻¹ term.

6. The method as recited in any previous embodiment, wherein the Ginzburg-Landau energy fidelity term comprises a least squares fit.

7. The method as recited in any previous embodiment, wherein the segmenting comprises binary segmentation by a spectral clustering algorithm.

8. The method as recited in any previous embodiment, wherein the graph Laplacian is a symmetric Laplacian.

9. The method as recited in any previous embodiment, wherein the graph Laplacian is a random walk Laplacian.

10. The method as recited in any previous embodiment, further comprising convex splitting a graph Lapalcian.

11. The method as recited in any previous embodiment, further comprising calculating a Nyström extension on a symmetric graph Laplacian.

12. A non-transitory computer-readable storage medium having an executable program stored thereon, wherein the program instructs a computer to perform steps comprising: (a) specifying an initial set of features within a data set; (b) determining edge weights with a similarity function w(x,y); (c) building a graph based on the determined edge weights; (d) minimizing a Ginzburg-Landau energy functional with one or more constraints or fidelity terms; and (e) segmenting data into two classes.

13. The program as recited in any previous embodiment, wherein the similarity function comprises a Gaussian function w(x,y)=exp(−∥x−y∥²/τ.

14. The program as recited in any previous embodiment, wherein the similarity function comprises:

$$w ( x , y ) = exp ( \frac{{d ( x , y )}^{2}}{\sqrt{τ ( x ) τ ( y )}} ) .$$

15. The program as recited in any previous embodiment, wherein the Ginzburg-Landau energy functional constraint comprises a double well potential.

16. The program recited in as recited in any previous embodiment, wherein the Ginzburg-Landau energy functional constraint comprises an H⁻¹ term.

17. The program as recited in any previous embodiment, wherein the Ginzburg-Landau energy fidelity term comprises a least squares fit.

18. A computer system for modeling biochemical networks, comprising: a computation device configured for receiving data input; a non-transitory computer-readable storage medium having an executable program stored thereon, wherein the program instructs a computer to perform the operations comprising: (a) specifying an initial set of features within a data set; (b) determining edge weights with a similarity function w(x,y); (c) building a graph based on the determined edge weights; (d) minimizing a Ginzburg-Landau energy functional with one or more constraints or fidelity terms; and (e) segmenting data into two classes.

19. The system as recited in any previous embodiment, further comprising: calculating a Nyström extension on a symmetric graph Laplacian.

20. The system as recited in any previous embodiment, wherein the similarity function comprises a Gaussian function w(x,y)=exp(−∥x−y∥²/τ.

21. The method as recited in any previous embodiment, wherein the convex splitting of a graph Lapalcian comprises: inputting an initial function u₀ and the eigenvalue-eigenvector pairs (\tilde{λ}\tilde{λₖ}, φₖ(x)) for the graph Laplacian Lₛ from

$$\begin{matrix}{L}_{8} = {D}^{- 1 / 2} {LD}^{- 1 / 2} \\ = I - {D}^{- \frac{1}{2}} {WD}^{- \frac{1}{2}} ;\end{matrix}$$

setting a convexity parameter c and an interface scale ε from the equation

$${E}_{2} ( u ) = - \frac{1}{4 ε} \int {( {u ( x )}^{2} - 1 )}^{2} d x + \frac{c}{2} \int {\vert u ( x ) \vert}^{2} d x - \int \frac{λ ( x )}{2} {( u ( x ) - {u}_{0} ( x ) )}^{2} d x ;$$

setting the time step dt; initializing aₖ⁽⁰⁾=∫u(x)φₖ(x)dx; initializing) bₖ⁽⁰⁾=∫[u₀(x)]³φₖ(x)dx; initializing dₖ⁽⁰⁾=0; calculating Dₖ=1+dt(ε\tilde{λ}\tilde{λₖ}+c); iterating for n less than a set number of iterations M:

$${a}_{k}^{( n + 1 )} = {𝒟}_{k}^{- 1} [ ( 1 + \frac{dt}{ε} + cdt ) {a}_{k}^{( n )} - \frac{dt}{ε} {b}_{k}^{( n )} - {dtd}_{k}^{( n )} ] , \\ {u}^{( n + 1 )} ( x ) = {\sum }_{k}^{ } {a}_{k}^{( n + 1 )} {φ}_{k} ( x ) , \\ {b}_{k}^{( n + 1 )} = \int {[ {u}^{( n + 1 )} ( x ) ]}^{3} {φ}_{k} ( x ) d x , \\ {d}_{k}^{( n + 1 )} = \int λ ( x ) ( {u}^{( n + 1 )} ( x ) - {u}_{0} ( x ) ) - {u}_{0} ( x ) ) {φ}_{k} ( x ) d x ;$$

and
outputting the function u^{(M)}(x).

22. The method recited in claim 7, wherein said convex splitting a graph Lapalcian comprises: inputting a set of features Z={xᵢ}^{l}ᵢ^{v}_{—1} partitioning the set Z into Z=X∪Y, where X consists of L randomly selected elements; calculating W_{XX} and W_{XY} using

$${W}_{XY} = [ \begin{matrix}w ( {x}_{1} , {y}_{1} ) & … & w ( {x}_{1} , {y}_{N - L} \\ ⋮ & ⋱ & ⋮ \\ w ( {x}_{L} , {y}_{1} & … & w ( {x}_{L} , {y}_{N - L}\end{matrix} ] ;$$

and outputting the L eigenvalue-eigenvector pairs (φᵢ, \tilde{λ}ᵢ), where φᵢ is the ith column of Φ and \tilde{λ}ᵢ=1−ξᵢ with ξᵢ the ith diagonal element of Ξ wherein d_{X}=W_{XX}1_{L} W_{XY}1_{N-L}; d_{Y}=W_{YX}1_{L} (W_{YX}W_{XX}⁻¹W_{XY})1_{N-L}; s_{X}=\sqrt{d_{X}} and s_{Y}=\sqrt{d^{Y}}; W_{XX}=W_{XX}·(s_{X}s_{X}^{T}); W_{XY}=W_{XY}·/(s_{X}s_{Y}^{T}); B_{X}ΓB_{X}^{T}=W_{XX};

$$S = {B}_{X} {Γ}^{- \frac{1}{2}} {B}_{X}^{T} ;$$

### Q=W_{XX}+S(W_{XY}W_{YX})S; AΞA^{T}=Q; and

wherein

$$Φ = [ \begin{matrix}{B}_{X} {Γ}^{\frac{1}{2}} \\ {W}_{YX} {B}_{X} {Γ}^{- 1 / 2}\end{matrix} ] {B}_{X}^{T} ( A {Ξ}^{- 1 / 2} )$$

diagonalizes W.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. A method for classifying high dimensional data comprising:
(a) specifying an initial set of features within a data set of high dimensional data;
(b) determining edge weights with a similarity function w(x,y);
(c) building a graph based on the determined edge weights;
(d) minimizing a Ginzburg-Landau energy functional with one or more constraints or fidelity terms; and
(e) segmenting data into two classes.

2. The method as recited in claim 1, wherein said similarity function comprises a Gaussian function w(x,y)=exp(−∥x−y∥²/τ.

3. The method as recited in claim 1, wherein said similarity function comprises
$$w ( x , y ) = exp ( \frac{{d ( x , y )}^{2}}{\sqrt{τ ( x ) τ ( y )}} ) .$$

4. The method as recited in claim 1, wherein said Ginzburg-Landau energy functional constraint comprises a double well potential.

5. The method as recited in claim 1, wherein said Ginzburg-Landau energy functional constraint comprises an H⁻¹ term.

6. The method as recited in claim 1, wherein said Ginzburg-Landau energy fidelity term comprises a least squares fit.

7. The method as recited in claim 1, wherein said segmenting comprises binary segmentation by a spectral clustering algorithm.

8. The method as recited in claim 1, wherein graph Laplacian is a symmetric Laplacian.

9. The method as recited in claim 1, wherein graph Laplacian is a random walk Laplacian.

10. The method as recited in claim 1, further comprising convex splitting a graph Lapalcian.

11. The method as recited in claim 1, further comprising calculating a Nyström extension on a symmetric graph Laplacian.

12. A non-transitory computer-readable storage medium having an executable program stored thereon, wherein the program instructs a computer to perform steps comprising:
(a) specifying an initial set of features within a data set;
(b) determining edge weights with a similarity function w(x,y);
(c) building a graph based on the determined edge weights;
(d) minimizing a Ginzburg-Landau energy functional with one or more constraints or fidelity terms; and
(e) segmenting data into two classes.

13. The program as recited in claim 12, wherein said similarity function comprises a Gaussian function w(x, y)=exp (−∥x−y∥²/τ.

14. The program as recited in claim 12, wherein said similarity function comprises:
$$w ( x , y ) = exp ( \frac{{d ( x , y )}^{2}}{\sqrt{τ ( x ) τ ( y )}} ) .$$

15. The program as recited in claim 12, wherein said Ginzburg-Landau energy functional constraint comprises a double well potential.

16. The program as recited in claim 12, wherein said Ginzburg-Landau energy functional constraint comprises an H⁻¹ term.

17. The program as recited in claim 12, wherein said Ginzburg-Landau energy fidelity term comprises a least squares fit.

18. A computer system for modeling biochemical networks, comprising:
a computation device configured for receiving data input;
a non-transitory computer-readable storage medium having an executable program stored thereon, wherein the program instructs a computer to perform the operations comprising:
(a) specifying an initial set of features within a data set;
(b) determining edge weights with a similarity function w(x,y);
(c) building a graph based on the determined edge weights;
(d) minimizing a Ginzburg-Landau energy functional with one or more constraints or fidelity terms; and
(e) segmenting data into two classes.

19. The system as recited in claim 18, further comprising calculating a Nyström extension on a symmetric graph Laplacian.

20. The system as recited in claim 12, wherein said similarity function comprises a Gaussian function w(x, y)=exp(−∥x−y∥²/τ.
